(19) United States
(12) Patent Application Publication
(10) Pub. No.: US 2008/0174541 A1
(43) Pub. Date: Jul. 24, 2008

(54) BACKLIGHT CONTROL CIRCUIT OF LCD

(75) Inventors: YING CHEN, Shenzhen (CN); JIN-LIANG XIONG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HON FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/843,667

(22) Filed: Aug. 23, 2007

(30) Foreign Application Priority Data
Jan. 24, 2007 (CN) 200710200103.2

(51) Int. Cl. G09G 3/36

(52) U.S. Cl. 345/102

(57) ABSTRACT

An exemplary backlight control circuit includes two load circuits, a PWM IC having a current sampling pin, a switching circuit, and a first input circuit. Each load circuit includes a backlight and an output. The switching circuit includes first and second transistors. The collector of the first transistor is coupled to the base of the second transistor. The outputs of the load circuit are coupled to the base of the first transistor via the first input circuit, or the collector of the second transistor which is coupled to a current sampling pin of the PWM IC. When any one of the backlights stops working, voltage at outputs of the load circuits goes low to cause, voltage at the current sampling pin of the PWM IC going low to thereby control the PWM IC to stop providing voltage to all the load circuits.

### BACKGROUND

1. Field of the Invention

The present invention relates to a backlight control circuit used in a liquid crystal display (LCD).

2. Description of Related Art

An LCD has the advantages of portability, low power consumption, and low radiation, and has been widely used in various portable information products such as notebooks, personal digital assistants (PDAs), video cameras and the like. Furthermore, the LCD is considered by many to have the potential to completely replace CRT (cathode ray tube) monitors and televisions.

A typical LCD includes an LCD panel, a plurality of backlights for illuminating the LCD panel, an inverter circuit for driving the backlights, and a backlight control circuit. The backlight control circuit generally includes a pulse width modulation integrated circuit (PWM IC) for driving the inverter circuit, and a backlight protection circuit for shutting down the PWM IC when any one of the backlights has an open circuit or a short circuit connecting to ground.

FIG. 3 is an abbreviated diagram of a typical backlight control circuit used in an LCD. The backlight control circuit 100 includes four load circuits 110, a PWM IC 150, and a backlight protection circuit (not labeled). The backlight protection circuit includes a first transistor 171, a current limiting resistor 172, and an input circuit 130.

Each load circuit 110 includes a backlight 111 and a backlight inspecting circuit 113 connected in series between a power supply (not shown) and ground. The backlight inspecting circuit 113 includes an output 112. The output 112 provides a high voltage when the corresponding backlight 111 works. The output 112 provides a low voltage when the corresponding backlight 111 has an open circuit or a short circuit connecting to ground.

The PWM IC 150 includes a current sampling pin 151. The PWM IC 150 stops working if the current sampling pin 151 has a low voltage.

A source of the first transistor 171 is connected to ground. A drain of the first transistor 171 is connected to the current sampling pin 151 of the PWM IC 150. A gate of the first transistor 171 is connected to a power supply via the current limiting resistor 172. The power supply is provided from a power pin (not labeled) of the PWM IC 150.

The input circuit 130 includes four diodes 131, four resistors 132, four capacitors 135, a second transistor 1331, a third transistor 1332, a fourth transistor 1333, and a fifth transistor 1334. Each transistor 1331, 1332, 1333, 1334 includes a source, a drain, and a gate. The drain of the fifth transistor 1334 is connected to the gate of the first transistor 171. The drain of the fourth transistor 1333 is connected to the source of the fifth transistor 1334. The drain of the third transistor 1332 is connected to the source of the fourth transistor 1333. The drain of the second transistor 1331 is connected to the source of the third transistor 1332. The source of the second transistor 1331 is connected to ground. The gates of the second, third, fourth, fifth transistors 1331, 1332, 1333, 1334 are connected to negative terminals of the four diodes 131, respectively. Positive terminals of the four diodes 131 are respectively connected to the outputs 112 of the backlight inspecting circuits 113. Each of the gates of the second, third, fourth, and fifth transistors 1331, 1332, 1333, 1334 is connected to ground via the corresponding resistor 132, and is connected to ground via the corresponding capacitor 135.

The first transistor 171, the second transistor 1332, the third transistor 1333, the fourth transistor 1334 and the fifth transistor 1335 are negative-channel metal oxide semiconductor (NMOS) type transistors.

The operation of the backlight control circuit 100 is as follows. When all the backlights 111 work normally, each of the outputs 112 provides a high voltage to the corresponding gates of the second, third, fourth, and fifth transistor 1331, 1332, 1333, 1334 via the corresponding diodes 131. Then the second, third, fourth, and fifth transistors 1331, 1332, 1333, 1334 are switched to an activated state, and the gate of the first transistor 171 is connected to ground via the activated second, third, fourth, and fifth transistors 1331, 1332, 1333, 1334. Thus the first transistor 171 is turned off, and the current sampling pin 151 of the PWM IC 150 maintains an original working voltage.

When any one of the backlights 111 has an open circuit or has a short circuit connecting to ground, the corresponding output 112 provides a low voltage to the gate of the corresponding transistor 1331, 1332, 1333, or 1334 via the corresponding diode 131. Then the corresponding transistor 1331, 1332, 1333, or 1334 is turned off, so that the gate of the first transistor 171 is changed to a high voltage by the power supply via the current limiting resistor 172. Thus the first transistor 171 is switched to an activated state, and the current sampling pin 151 of the PWM IC 150 is connected to ground via the activated first transistor 171. Consequently, the current sampling pin 151 of the PWM IC 150 is changed to a low voltage, and the PWM IC 150 stops working.

The backlight control circuit 100 includes the five transistors 171, 1331, 1332, 1333, 1334 needed to carry out the function of protecting the backlights 111. Further, the number of transistors needed increases with the number of backlights 111 used in the LCD. Consequently, the cost of the backlight control circuit 100 is high, particularly in the case where the number of backlights 111 is large.

What is needed, therefore, is a backlight control circuit used typically in an LCD which overcomes the above-described deficiency.

### SUMMARY

An exemplary An exemplary backlight control circuit includes two load circuits, a PWM IC having a current sampling pin, a switching circuit, and a first input circuit. Each load circuit includes a backlight and an output. The switching circuit includes first and second transistors. The collector of the first transistor is coupled to the base of the second transistor. The outputs of the load circuit are coupled to the base of the first transistor via the first input circuit, or the collector of the second transistor which is coupled to a current sampling pin of the PWM IC. When any one of the backlights stops working, voltage at outputs of the load circuits goes low to cause, voltage at the current sampling pin of the PWM IC going low to thereby control the PWM IC to stop providing voltage to all the load circuits.

Other advantages and novel features will become more apparent from the following detailed description when taken in conjunction with the accompanying drawings, in which:

### BRIEF DESCRIPTION OF THE DRAWINGS

FIG. 1 is a circuit diagram of a backlight control circuit used in an LCD according to a first embodiment of the present invention;

FIG. 2 is a circuit diagram of a backlight control circuit used in an LCD according to a second embodiment of the present invention; and

FIG. 3 is a circuit diagram of a conventional backlight control circuit used in an LCD.

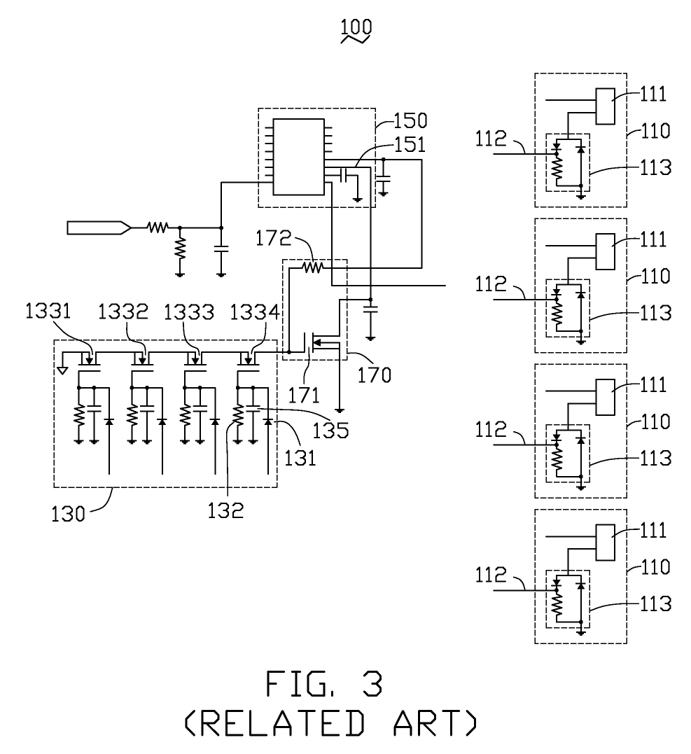

### DETAILED DESCRIPTION OF THE INVENTION

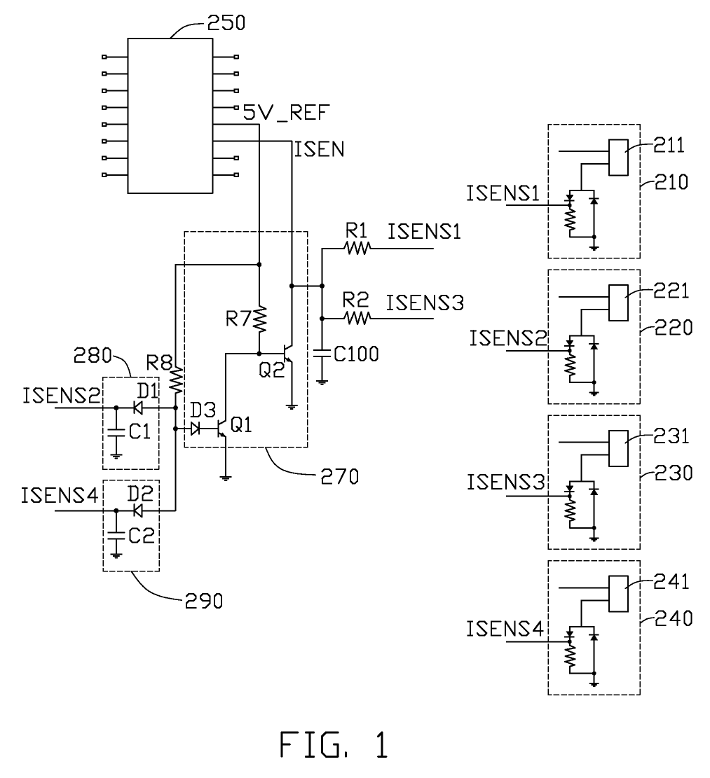

Referring to FIG. 1, a backlight control circuit in accordance with a first embodiment of the present invention includes four load circuits 210, 220, 230, 240, a PWM IC 250, and a backlight protection circuit. The backlight protection circuit includes a switching circuit 270, a first input circuit 280, and a second input circuit 290.

The load circuit 210 includes a backlight 211 and a backlight inspecting circuit connected in series between a power supply and ground. The backlight inspecting circuit includes two diodes and a resistor. An anode of one of the diodes and a cathode of the other diode are connected together to the power supply via the backlight 211. A cathode of the one diode is connected to one end of the resistor. The other end of the resistor and an anode of the other diode are connected to ground. The backlight inspecting circuit includes an output ISENS1 connected to a node between the one diode and the resistor. The load circuits 220, 230, and 240 each have a same structure as the load circuit 210. The backlights of the load circuits 220, 230, and 240 are labeled as 221, 231, 241, respectively. The outputs of the load circuits 220, 230, and 240 are labeled as ISENS2, ISENS3, ISENS4, respectively. Each of the outputs ISENS1, ISENS2, ISENS3, ISENS4 is at a high voltage when the corresponding backlight 211, backlight 221, backlight 231, or backlight 241 works normally. The outputs ISENS1, ISENS2, ISENS3, ISENS4 are low voltage when the corresponding backlight 211, backlight 221, backlight 231, or backlight 241 has an open circuit or a short circuit connecting to ground.

The PWM IC 250 includes a current sampling pin ISEN. The PWM IC 250 stops working if the current sampling pin ISEN has a low voltage.

The switching circuit 270 includes two transistors Q1, Q2, a diode D3, and a resistor R7. The transistor Q1 has a base connected to a cathode of the diode D3, an emitter connected to ground, and a collector connected to a direct current power supply via the resistor R7. The power supply is provided by a power pin 5V_REF of the PWM IC 250. The transistor Q2 has a base connected to the collector of the transistor Q1, an emitter connected to ground, and a collector connected to the current sampling pin ISEN of the PWM IC 250, and connected to ground via a capacitor C100. An anode of the diode D3 is connected to the power pin 5V_REF of the PWM IC 250 via a resistor R8. The outputs ISENS1, ISENS3 of the load circuits 210, 230 are connected to the collector of the transistor Q2 via resistors R1, R3.

The first input circuit 280 includes a diode D1, and a capacitor C1. A cathode of the diode D1 is connected to ground via the capacitor C1, an anode of the diode D1 is connected to the anode of the diode D3. A node between the cathode of the diode D1 and the capacitor C1 is connected to the output ISENS2 of the load circuit 220.

The second input circuit 290 includes a diode D2, and a capacitor C2. A cathode of the diode D2 is connected to ground via the capacitor C2, an anode of the diode D2 is connected to the anode of the diode D3. A node between the cathode of the diode D2 and the capacitor C2 is connected to the output ISENS4 of the load circuit 240.

Generally, operation of the backlight control circuit is as follows. When all the backlights 211, 221, 231, 241 work normally, voltage at each of the outputs ISENS1, ISENS2, ISENS3, ISENS4 is high. The high voltage at the outputs ISENS2 and ISENS4 provide to the cathodes of the diodes D1 and D2, the diodes D1 and D2 are turned off, the transistor Q1 is turned on, the transistor Q2 is turned off, the voltage at the collector Q2 is high, and the current sampling pin ISEN of the PWM IC 250 maintains an original working voltage.

When any one of the backlights 211, 221, 231, 241 has an open circuit or has a short circuit connecting to ground, voltage at the corresponding output ISENS1, ISENS2, ISENS3, ISENS4 is low. If the backlight 221 has an open circuit, and the other backlights work normally, voltage at the output ISENS2 of the load circuit 220 is low, the diode D1 is turned on, the transistor Q1 is turned off, the transistor Q2 is turned on, the collector of the transistor Q2 has a low voltage, and the current sampling pin ISEN of the PWM IC 250 is connected to ground via the activated transistor Q2. Consequently, the current sampling pin ISEN of the PWM IC 250 is changed to a low voltage, and the PWM IC 150 stops working.

If the backlight 241 works abnormally, the operation of the backlight control circuit is same with the backlight 221.

If the backlight 211 works abnormally, voltage at the output ISENS1 is low, the current sampling pin ISEN of the PWM IC 250 receives the low voltage via the resistor R1. Consequently, the current sampling pin ISEN of the PWM IC 250 is changed to a low voltage, and the PWM IC 150 stops working.

If the backlight 231 works abnormally, the operation of the backlight control circuit is the same as the backlight 211.

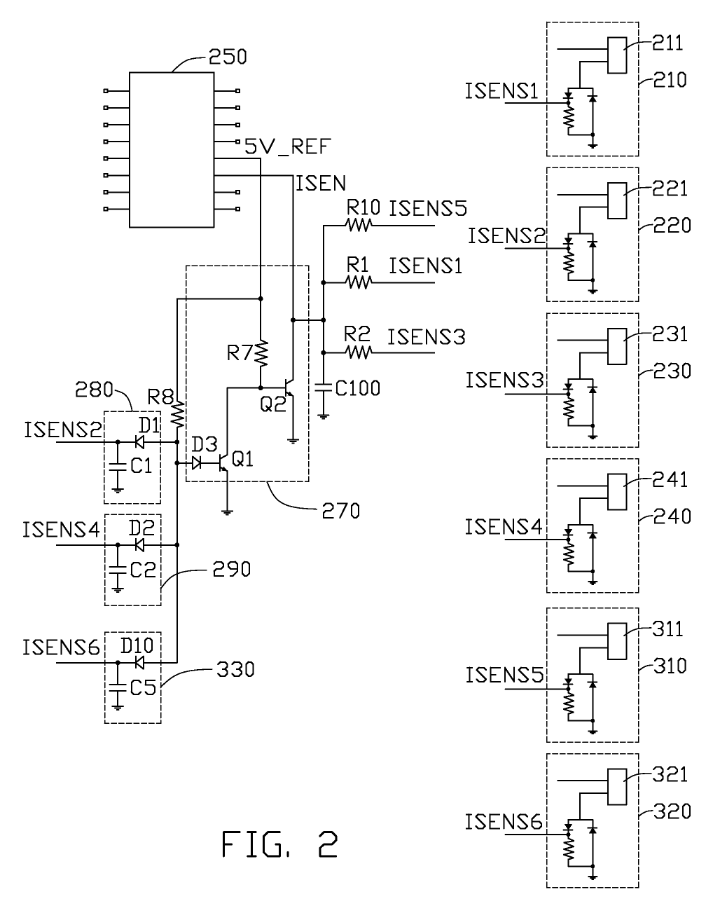

FIG. 2 is a circuit diagram of a backlight control circuit according to a second embodiment of the present invention. The circuit of FIG. 2 is similar to FIG. 1, the difference between the circuit of FIG. 2 and FIG. 1 is that the backlight control circuit of FIG. 2 further includes a fifth load circuit 310, a sixth load circuit 320, a resistor R10, and a third input circuit 330 in addition to the circuits of the FIG. 1.

The load circuit 310 includes a backlight 311 and a backlight inspecting circuit connected in series between a power supply and ground. The backlight inspecting circuit includes an output ISENS5 connected to the collector of the transistor Q2 via the resistor R10.

The load circuit 320 includes a backlight 321 and a backlight inspecting circuit connected in series between a power supply and ground. The backlight inspecting circuit includes an output ISENS6.

The third input circuit 330 includes a diode D10, and a capacitor C5. A cathode of the diode D10 is connected to ground via the capacitor C5, an anode of the diode D10 is connected to the anode of the diode D3. A node between the cathode of the diode D10 and the capacitor C5 is connected to the outputs ISENS6 of the load circuit 320.

If the backlight 311 works abnormally, the operation of the backlight control circuit is with the same as the backlight 211. If the backlight 321 works abnormally, the operation of the backlight control circuit is with the same as the backlight 221.

The backlight control circuit of the present invention needs only two transistors Q1, Q2 to carry out the function of protecting the backlights. Further, the number of transistors need not increase with an increase in the number of backlights used in the LCD. Therefore, the backlight control circuit has a low cost.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A backlight control circuit comprising:
a first load circuit comprising a first backlight and a first backlight inspecting circuit connected in series, the first inspecting circuit comprising a first output;
a second load circuit comprising a second backlight and a second backlight inspecting circuit connected in series, the second inspecting circuit comprising a second output;
a pulse width modulation integrated circuit (PWM IC) comprising a current sampling pin;
a switching circuit comprising a first transistor, a second transistor, a first diode, and a first resistor, the first transistor having a base connected to a cathode of the first diode, an emitter being grounded, and a collector connected to a power supply via the first resistor, the second transistor having a base connected to the collector of the first transistor, an emitter being grounded, and a collector connected to the current sampling pin of the PWM IC, and connected to ground via a capacitor, an anode of the first diode connected to the power supply, the first output of the first load circuit connected to the collector of the second transistor via a second resistor; and
a first input circuit comprising a second diode, an anode of the second diode connected to the anode of the first diode, and a cathode of the second diode connected to the second output of the second load circuit.

2. The backlight control circuit as claimed in claim 1, further comprising:
a third load circuit comprising a third backlight and a third backlight inspecting circuit connected in series, the third inspecting circuit comprising a third output, the third output of the third load circuit connected to the collector of the second transistor via a third resistor;
a fourth load circuit comprising a fourth backlight and a fourth backlight inspecting circuit connected in series, the fourth inspecting circuit comprising a fourth output; and
a second input circuit comprising a third diode, an anode of the third diode connected to the anode of the first diode, and a cathode of the third diode connected to the fourth output of the fourth load circuit.

3. The backlight control circuit as claimed in claim 1, wherein the cathode of the second diode is grounded via another capacitor.

4. The backlight control circuit as claimed in claim 2, wherein the cathode of the third diode is grounded via another capacitor.

5. A backlight control circuit comprising:
a first load circuit comprising a first backlight and a first backlight inspecting circuit connected in series, the first inspecting circuit comprising a first output;
a second load circuit comprising a second backlight and a second backlight inspecting circuit connected in series, the second inspecting circuit comprising a second output;
a pulse width modulation integrated circuit (PWM IC) comprising a current sampling pin;
a switching circuit comprising a first transistor, a second transistor, a first diode, and
a first resistor, the first transistor having a base connected to a cathode of the first diode, an emitter connected to ground, and a collector connected to a power supply via the first resistor, the second transistor having a base connected to the collector of the first transistor, an emitter connected ground, and a collector connected to the current sampling pin of the PWM IC, and connected to ground via a capacitor, an anode of the first diode connected to the power supply;
a first input circuit comprising a second diode, an anode of the second diode connected to the anode of the first diode, and a cathode of the second diode connected to the first output of the first load circuit; and
a second input circuit comprising a third diode, an anode of the third diode connected to the anode of the first diode, and a cathode of the third diode connected to the second output of the second load circuit.

6. The backlight control circuit as claimed in claim 5, further comprising a third load circuit comprising a third backlight and a third backlight inspecting circuit connected in series, wherein the third inspecting circuit comprises a third output coupled to the collector of the second transistor.
